(19) United States
(12) Patent Application Publication
(10) Pub. No.: US 2020/0043106 A1
(43) Pub. Date: Feb. 6, 2020

(54) SYSTEMS AND METHODS FOR DISTRIBUTION SYSTEM MARKETS IN ELECTRIC POWER SYSTEMS

(71) Applicant: Opus One Solutions Energy Corp., Richmond Hill (CA)

(72) Inventors: Joshua Wong, Toronto (CA); Hisham Omara, Woodbridge (CA); Subramaniam Harisuthan, Toronto (CA); Ben Ullman, Brooklyn, NY (US); Gerhard Walker, Melrose, MA (US); Cong Wang, Thornhill (CA); David MacRae, New York (US)

(73) Assignee: Opus One Solutions Energy Corp., Richmond Hill (CA)

(21) Appl. No.: 16/443,518

(22) Filed: Jun. 17, 2019

Related U.S. Application Data
(60) Provisional application No. 62/685,750, filed on Jun. 15, 2018.

(51) Int. Cl. G06Q 50/06; H02J 3/38

(52) U.S. Cl. CPC G06Q 50/06; H02J 3/381

(57) ABSTRACT

A system is disclosed which integrates physical system conditions and multiple DER ownership models, and provides a bridge between DSM and wholesale/utility supply and demand to operate a market which sites and utilizes assets optimally. The DSM is technology agnostic, subject to business rules, and is focused on generating reductions in just and reasonable grid costs by assigning value based on granular location- and time-specific valuations.

This application is a non-provisional of U.S. Provisional Patent Application No. 62/685,750 filed Jun. 15, 2018, the entire disclosure of which is incorporated herein by reference.

This application includes material which is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND

Electric Power Distribution Systems were built to reliably deliver power to consumers. Those power systems and the markets that define the transactions within them have been designed around a one-way flow of power—generally from large generators in the bulk electric system to consumers in distribution systems. Customers are charged fees based on the power they consume and distribution service charge, which is typically a socialized cost to cover the maintenance and necessary upgrades of the systems. The fees are mostly flat rates set through a regulatory process and vary by distribution utility. For the most part, utility rates do not vary by geographic location within a utility's territory, or by time of use. The mostly flat pricing structure is an outcome of the mostly inelastic demand consumers have historically had for electricity.

These rate structures are designed to cover the planning, investment into, and operation of the power system. More granular, time and location resolved prices that reflect the ability of distribution system assets to impact energy consumption and generation, and, more generally, grid services, are the key to a grid where planning, investment, and operation operate in sync to reduce waste and maximize social benefits.

Today, prosumers, a new class of empowered participant in the electricity network, whose consumption, generation, storage, and on/off grid decisions respond to energy prices, are impacting grid operations in increasing magnitude and only promise to further alter the industry, going forward. These prosumers are further empowered by a class of new and emerging technologies called Distributed Energy Resources (DERs) which allow prosumers ranging from passive consumers to utilities to interact with each other in new, networked ways.

DERs include solar, wind, batteries, combined heat and power plants, microgrids, fuel cells, demand response (e.g. controllable home appliances), energy efficiency, and electric vehicle chargers with vehicle to grid capabilities among others. In conjunction with DERs, distribution grid automation assets such as capacitor banks, voltage regulators and load tap changers can provide distribution grid services such as energy, ancillary services, storage and resiliency. The changing economics around these technologies give them the potential to more significantly impact the grid (i.e. increased capacity due to solar, wind, batteries and combined heat and power technologies).

Connecting those DERs to each other, to other consumers, the larger distribution grid, and the bulk power system requires a coordination effort enabled by software that results in a platform with greater network benefits as more users and services are added. The larger the network, the more robust the platform, the greater the positive impact end users can have on each other and the grid at large. To that end, the software systems, controls, and platforms do not yet exist and operate together at the distribution system level in a way that allows for a coordinated distribution system response to changing grid needs, market trends, and consumer desires.

In the parts of the bulk electric system, a wholesale market or balancing authority manages the coordination effort between energy generating assets, the transmission system which carries their power, and distribution utilities which deliver power to consumers. In those markets, companies managing large generators sell power, while load serving entities (LSEs) purchase energy from those generators on behalf of their ratepayers. Generally, market power is thought to be reduced in those markets through regulations which encourage generators to offer power at prices reflective of short-term costs, leading to an energy price that reflects the price to serve the marginal (i.e. an additional) unit of energy at a given location, at a given point in time.

The location- and time-specific price in deregulated wholesale markets that is assigned to power minimizes the cost to serve an incremental unit of power and creates a location-specific incentive for investment in new assets and operation of existing ones. The system optimizes for the ability of the assets in its system to meet the needs of the consumers based on the varied characteristics of those assets.

However, those bulk power systems markets, as complex and sophisticated as they are, do not yet extend to the distribution system, nor do they yet have the ability to contemplate the new capabilities of assets on the far more complex distribution system.

A new economic, business model and market structure, that makes the most of prosumers' rapidly developing abilities to provide grid services ranging response, requires a linkage between those DERs and the grid that allows those assets' impacts to be optimized. That linkage does not yet exist as a platform which solves for those economic and social goals subject to physical constraints such as capacity, hosting capacity and contingency. This new economic structure is typically referred to as transactive energy, which is defined by the GridWise Architecture Council as a “set of economic and control mechanisms that allows the dynamic balance of supply and demand across the entire electrical infrastructure using value as a key operational parameter”. When transactive energy is realized in a market structure, the platform is commonly referred to as a distribution system market (DSM), transactive energy market, or the market function in a distributed system platform.

Maximizing the benefit that a transactive energy construct can bring about requires a new connection between not only the distribution system and the myriad of assets contained within, but also between the distribution system and the bulk system above it. Optimizing the DERs that exist on the grid today and will be installed tomorrow requires operational signals that utilize those assets as installations and investment plans assumed. In wholesale markets, those operational signals take the form of prices. To generate similarly impactful operational signals at the distribution level, advanced metering, communication, and controller logic and distribution grid modeling that includes power flow, grid constraints, and grid objectives must be implemented alongside market rules. Linking the business rules to the metering, communication, modelling, and controllers requires software platforms designed to be scalable and to operate as markets, continuously integrating new assets as they connect to the grid.

Regulators today are grappling with how to best create incentives for and operate those assets at the distribution level, such as with net energy metering, time of use rates and feed-in-tariffs. What's common across regulators' requests is a desire for a more granular, location- and time-specific understanding of the distribution grid, the capabilities of assets currently on and soon to join the grid, better communication between assets and systems, and coordinated control of those assets to maximize their positive impact on the grid and mitigate negative impacts.

At the state level, New York's Public Service Commission (PSC), the state's entity which regulates the relationships between distribution utilities and consumers, has enacted the “New York Reforming the Energy Vision” initiative to accelerate the development of a new energy future across the state. Key to that new energy future is a set of economic signals and controls for the new assets that will define the state's future energy infrastructure. That infrastructure will be managed in a Distributed System Platform—“an intelligent network platform that will provide safe, reliable, and efficient electric services by integrating diverse resources to meet customers' and society's evolving needs.” “The DSP fosters broad market activity that monetizes system and social values, by enabling active customer and third-party engagement that is aligned with the wholesale market and bulk power system.”

The combination of those market-generated economic signals and device-level controls enable management of DERs that reflects the grid's needs and operator's goals in a construct that is sometimes referred to as ‘Transactive Energy.’ Transactive Energy contemplates decisions on unit operation are based on value, and value exchange in the distribution grid based on economics. Crucial to maximizing the beneficial potential of transactive energy is a system which correctly evaluates the economic value of those energy services.

Those controls and business models are in many ways an extension of the bulk system, where requests for better information about the distribution system exist, too. The Federal Energy Regulatory Commission's (FERC) rulemaking on storage assets' participation in Regional Markets and Notice Inviting Comments regarding Distributed Energy Resources' impacts on the bulk power system ask for comments from market participants including utilities and project developers about the ways in which the distribution system and bulk system could better coordinate action.

The FERC's concerns regarding DERs are mostly around their impacts on bulk system dispatch and pricing, and planning. The greater the share of total generation and consumption which DERs represent, the greater their impact on dispatch, and thus on prices, and planning all else held equal. The Distributed System Market's ability to connect distribution system assets with each other and the bulk system would allow it to resolve the FERC's concerns in ways that today's systems cannot.

Indeed, California's grid operator which responds to the FERC, the California Independent System Operator (CAISO), has suffered from a ‘duck curve’ in which prices fall precipitously during hours in which solar generation is online, and then rise steeply as solar generation falls off and expensive peaking units having to ramp up their generation to balance the grid.

The FERC, PSCs, and ISOs are in agreement that DERs have the potential to aide the power system. However, they also agree that for that aide to be maximized, better coordination and re-thinking distribution system operation is necessary. Similarly, utilities acknowledge that increased proliferation of DERs on their system creates cost recovery and cost socialization problems as flat rates for power paid to those distribution system assets may not accurately reflect the costs they impose on the grid, or benefit they bring to the grid.

Currently, certain DERs are compensated through regulated programs codified in annually or semi-annually updated tariffs. These programs and tariffs vary by utility, by state and are designed around meeting specific policy goals. A DSM that is technology agnostic, and more easily enables policy flexibility or broader market participation is an evolution of those distribution level incentive programs.

These incentive programs are generally called “Net Energy Metering” (allows customers to export energy to the grid and re-import that energy at a given point in time for no, or just a limited charge) or “Feed-In-Tariffs” (provide customers with a fixed, time and service independent compensation in $/kWh for exported energy) and pay generation owners a rate close to their retail rate for generation in excess of their consumption produced by their system. These programs do not generally contemplate complex two-way power flow or price responsiveness beyond annual tariffs and asset investment decisions.

Instead of addressing those modern grid issues, this approach was established in part to accelerate and simplify the home and large-scale solar installation process. The programs were created in an era when solar panels were more expensive, communications and controls technology were less well-developed for the distribution utility sector, and, crucially, when fewer customer-sited technologies existed which could meet the distribution system's needs and alter the bulk system's operations.

Drawbacks of the Net Energy Metering and Feed-in-Tariff approaches are mostly related to the lack of location and time specificity with which they compensate qualifying assets:
Rates paid to DER owners and developers may not necessarily reflect the marginal cost imposed on the system by their systems, or the marginal benefit brought to the system by their panels.
Rates paid to those DERs tend to value energy consumption or generation and fail to take into account the DER's ability to provide other energy services such as:
   Capital deferral
   Frequency Regulation
   Voltage Support
   Loss Minimization
   Hosting Capacity Management
   Spinning Reserves
   Peak load reduction

### SUMMARY

In both the operational and the rate-setting problems, a solution exists in more granular pricing, better communication, and better coordination.

In an embodiment, the invention provides a system which utilizes the integration of physical system conditions, multiple DER ownership models, and a bridge between the DSM system and wholesale/utility supply and demand to operate a market which sites, utilizes and remunerates assets optimally.

Whereas Net Energy Metering, Demand Response, and other DER compensation mechanisms target specific technologies and grant them mostly undifferentiated rates, the presently disclosed DSM is technology agnostic, subject to business rules, which includes market rules, and is instead focused on generating reductions in just and reasonable grid costs by assigning value based on granular location- and time-specific valuations.

In an embodiment, the present invention provides technologies which bridge the gap between the bulk and distribution systems and between distribution systems and the DERs contained within them, to provide an interface between the three which concurrently optimizes their operations. That interface represents a business model evolution in which energy services and energy asset investment decisions are made by a wider range of market participants based on a wider range of market signals.

Transactive energy and distribution system markets in Electric Power Systems are the solution to matching the distribution system's new capabilities with consumers', prosumers', DER developers', aggregators', utilities', planners', policy makers' and investors' goals.

An objective of the invention is to define the systems and methods which comprise a distribution system market (DSM) that solves the problems of uncoordinated distribution asset operation and investment through value-based controls (for example, price-based controls) and an interface for simultaneous optimization of the connection between the bulk and distribution systems.

The fully-realized version of a DSM contains information about assets at the distribution level, knowledge and measurement of the grid those assets are connected to, the ability to communicate signals between those assets and the utility, and the ability of the utility to communicate those capabilities to the bulk power system for signal generation that benefits the entire grid, rather than only portions of it.

By design, the system utilizes time and location specific prices for energy derived through technical and economic optimization subject to physics-founded constraints and market rules. This optimization will bring about incentives for siting the right resources at the right locations, and for operating those resources in ways that maximize their benefits.

In an embodiment, the system uses a distribution system state estimation (DSSE) to attain full visibility into all operational power-flow parameters which, in combination with a state of the art optimal power flow engine (OPF) enables the generation of dispatch instructions based on unit marginal costs.

In an embodiment, the business rules determining operations are based on a combination of distribution system and bulk energy system values.

Dispatch can be based solely on a distribution locational time-variable price (for example, a marginal price) in a microgrid islanded from the bulk system, or a combination of distribution locational marginal prices and wholesale locational marginal prices, depending on system planner goals.

In an embodiment, the invention provides an interoperable system that allows the operator the flexibility to meet their goals at lowest cost.

The enabling technologies behind that optimization are the communications, controls, and rules that combine to create a market which increases transparency and granularity in pricing and opens asset ownership to more classes of participants for a grid with more competitive participation that more robustly and repeatably achieves societal goals.

In an embodiment, the present invention codifies an integrated approach to markets. The technologies and processes which comprise this patent concern communications protocols, business rules development, and power systems modeling which allow tomorrow's grids to serve consumers' needs at a lower cost without reducing reliability.

The circumstances leading to its filing are changes in technology, society, customer expectations, policy, regulations, and environmental factors, which enable the integrated DSM to fully realize its potential.

New assets such as batteries, and new controls such associated with connected devices, and new software protocols can create the best possible grid of the future, but only if optimally tied together.

### BRIEF DESCRIPTION OF THE DRAWINGS

FIG. 1 shows a diagram illustrating inputs systems, DSM functions, and outputs systems associated with an embodiment of the presently disclosed DSM.

FIG. 2 shows a diagram illustrating DER Market Participants' interactions with the presently disclosed DSM and the presently disclosed DSM's interactions with the wholesale market.

FIG. 3 shows a block diagram of a data processing system components of which can be used as the processor in various embodiments of the disclosed systems and methods.

FIG. 4 shows a block diagram of a user device.

### DETAILED DESCRIPTION

Reference will now be made in detail to the preferred embodiments of the present invention, examples of which are illustrated in the accompanying drawings. The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

Reference in this specification to “an embodiment” or “the embodiment” means that a particular feature, structure, or characteristic described in connection with the embodiment is included in at least an embodiment of the disclosure. The appearances of the phrase “in an embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present invention is described below with reference to block diagrams and operational illustrations of methods and devices for providing distribution system markets in electrical power systems. It is understood that each block of the block diagrams or operational illustrations, and combinations of blocks in the block diagrams or operational illustrations, may be implemented by means of analog or digital hardware and computer program instructions. These computer program instructions may be stored on computer-readable media and provided to a processor of a general-purpose computer, special-purpose computer, ASIC, or other programmable data processing apparatus, such that the instructions, which execute via the processor of the computer or other programmable data processing apparatus, implements the functions/acts specified in the block diagrams or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

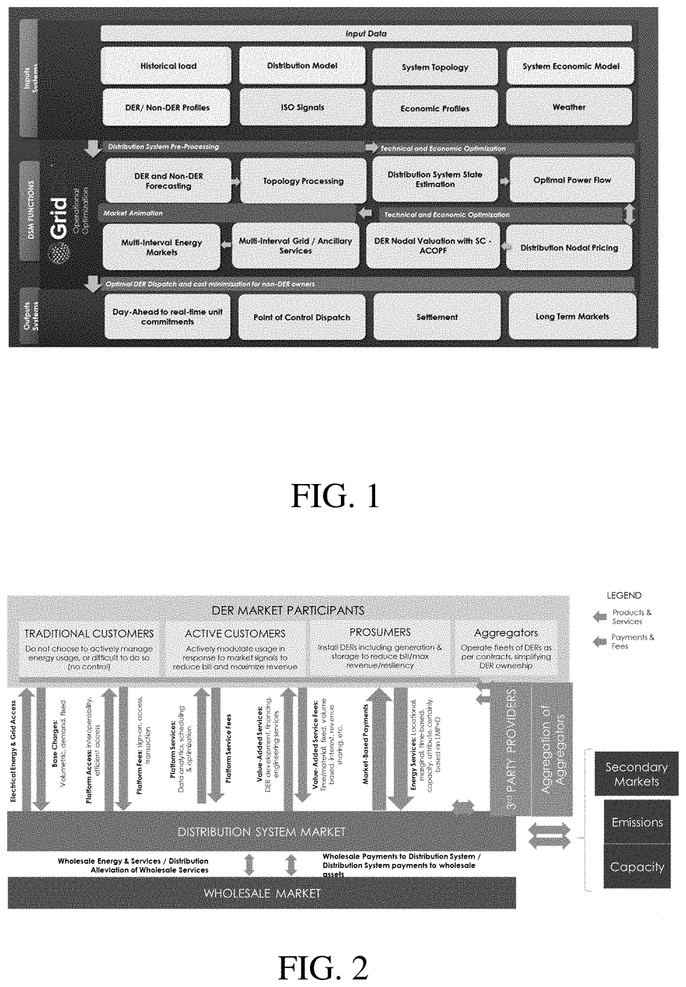

FIG. 1 shows a diagram illustrating inputs systems, DSM functions, and outputs systems associated with an embodiment of the presently disclosed DSM. FIG. 2 shows a diagram illustrating DER Market Participants' interactions with the presently disclosed DSM and the presently disclosed DSM's interactions with the wholesale market.

With reference to FIGS. 1 and 2, the Distributed System Market can function as a platform connecting assets at the distribution level to each other, the distribution system beyond their local area, and the bulk electric system from which they previously only purchased power from. In an embodiment, the platform operates across both short term, i.e. operational decisions, and long-term, i.e. investment and planning decisions, time frames to optimize the value of the grid services it facilitates.

Market Participants (MPs) include market operators, DER owners, DER operators, aggregators of DERs, energy services traders, energy services companies, retailers, and the utility, among others.
Market Operator: the entity which sends dispatch instructions to the DER operators.
Utility: the distribution utility may play a demand or supply-side role in the market which resides within its territory, depending on regulations, which is not critical to managing the reliability, resiliency, quality, access by DERs, and cost effectiveness of the network.
ISO: the ISO/RTO within which a utility resides may use the DSM in multiple ways. It may actively play a demand or supply role in the DSM and incorporate DERs into its forecast, or even generate its prices based on bids and offers from the DSM or from independent DERs which then receive that price as part of their operating revenue, or passively rely on the market to communicate a signal about forecasted load and system conditions for moment-to-moment ISO/RTO operation.
Aggregators: Aggregator MPs bid or offer more than one DER into the DSM based on contracts negotiated between the aggregator and the DER owner.
DER owner: the DER owner is the entity which owns the DER in the DSM. The DER owner need not operate the DER.
DER Operator: the entity which communicates with the DSM and operates the DER in accordance with the DSM's instructions.

### Short Term Markets: Functions and Characteristics:

Short term markets form the basis of the day-to-day interaction between the DSM's participants. These markets plan and operate the DSM's assets on time frames reflective of asset operation constraints, rather than asset investment and construction constraints. Generally, these markets will consist of day-ahead and same-day settlement with location-specific price fluctuations as granular as every 5 minutes in week-ahead, day-ahead, and same-day markets.

A goal of granular pricing based on wholesale market integration, or vertically integrated utility costs, is for DSM operation signals to capture the full-value a DER provides to the distribution grid and bulk energy system. Increased pricing granularity allows for operation instructions tailored to the unique characteristics of the asset which maximizes their beneficial impacts. In an embodiment, these markets can:
1. Generate operation signals based on a combination of wholesale prices and distribution-level price signals which reflect the value DERs bring to the distribution grid and the bulk system above them.
   a. Prices generated by the market need not be used for settlement. May simply be the prices which make up the shadow market and define operational dispatch.
2. Aggregate distribution level bids and offers, collected as either hierarchical, sealed bids and offers from aggregators, or a market-controlled aggregated bid based on system optimization.

### Price Formation

Location and time-specific values are the basis of DSM operation.
Price formation will reflect the input of all supply, demand, and storage (assets which may act as both supply and demand) resources in the DSM.
The dispatch generated by the optimization function is based on asset pricing which reflects the cost to deliver the commodity to a specific area over a specific time frame.
The DSM generates pricing based on its network of DERs and the business rules tying them to each other as well as the broader grid.
The DSM exposes those prices to market participants, either for settlement, informational, or both purposes.
The DSM allows for participants to transact with either the DSM or with individual market participants based on those prices, or a subset of those prices.
The DSM's prices are generated for same-day, day-ahead, and, potentially longer time periods based on forecasts incorporated into the pricing and dispatch engines.
Additional price inputs:
   Bulk System Locational Marginal Prices (LMP)
      The Bulk or utility energy system's marginal price at a given location for a single hour.
   Distribution System Abated Costs the value the DER brings to the distribution system.
      These abated costs may include distribution system marginal costs of service, avoided O&M, avoided distribution system losses, expressed in $/MWh terms and added to the bulk energy system price.
Distribution Locational Marginal Price (DLMP)
   A DLMP may incorporate the bulk energy system's LMP, or may reflect only the cost to serve power to a node within a distribution system without consideration for avoided costs. A DLMP may be calculated by minimizing the cost to serve power in an area subject to the area's DERs' operating characteristics, system topology, and loads.
   In certain instances, a DLMP may replace a bulk system price and any additional distribution system values for compensation and dispatch. In others, the DLMP may be used only for dispatch, but not for settlement.

### Services and Value Streams Considered in Evaluating DER Value

Depending on the market construct, the below distribution system economic and physical variables will implicitly or explicitly impact pricing. Pricing will reflect the value a DER brings to the distribution system. Distribution system values contain, at the least, the following categories:
   Capital deferral,
   loss minimization,
   voltage regulation,
   conservative voltage reduction,
   capacity planning/reductions,
   transfer capacity for restoration,
   ride-through for stability,
   reserves for emergency capacity,
   black start for reliability
   Energy generation
   Ancillary services provision including:
      Voltage support
      VAR optimization
      Frequency Regulation
      Transfer capacity
      Restoration capacity
   Energy Services include:
      Energy supply
      Storage supply
      Microgriding capacity
   Energy and Ancillary Services co-optimization
      Energy and ancillary services can sometimes be procured from the same asset, but generally not concurrently.
      The DSM will be able to co-optimize energy and ancillary services supply based on economic value to the system and to the asset supplying the specified service.

### DER Unit Commitment and Market Optimization

Different DERs each have a unique set of operational capabilities and abilities to supply grid services such as energy, capacity, ancillary services, reliability, or islanding capabilities. As such, DER participation in a DSM may be based on an asset's operational characteristics as well as submitted bids and offers compared against market demand and supply.

DERs may submit price, quantity, duration bid/offer triplets depending on whether they are, respectively, purchasing or selling grid services. Those triplets either implicitly account for the below DER operational constraints, or those operational constraints are contained in a separate database which is evaluated alongside the DER's price, quantity, duration triplet to determine the least cost dispatch solution:
Notification Time
Minimum Run time
Unit Emissions
Minimum Down time
Minimum Start time
Minimum kW
Maximum kW
Minimum kVAR
Maximum kVAR
Start up profile
Shut down profile
Hot to cold time
Hot to intermediate time
No load cost
Blackstart costs
Microgriding capabilities
Ridethrough

It is the responsibility of either the DER owner or the DER aggregator to ensure bids submitted to the DSP reflect the DER's operational characteristics.

In addition to the DER supply offers, DER non-owning entities may submit their own bids for power or be part of grouped bids for power.

The DSM will then balance the bids and offers by performing a least cost optimization based on system topology, DER characteristics, and forecast loads.

### Aggregation

The DSM can in some cases operate aggregators. Aggregators are entities which manage multiple DERs based on agreed upon contracts. Those aggregators may, for example, hold the rights to bid solar panels and batteries purchased by homeowners into a marketplace.

The DSM will then aggregate the demand and supply bids and offers submitted by aggregators, as well as the energy services supplied by the aggregators, into a least-cost solution to serve the short-term needs of the grid.

Aggregators in the DSM may be coordinated so that their operation is based on maximizing their combined marginal benefit to the distribution and bulk systems. In this way, the DSM may be thought of as an aggregator of aggregators.

If markets are operated under bid/offer constructs as elaborated above, Aggregators may submit bids/offers representing individual or aggregated DERs in their portfolio. The decision of how to aggregate may be made by the DER owner, the aggregator, or the DSM.

### Dispatch

Dispatch of DERs is done based on a multi-objective, multi-agent optimization which reflects the physics of the grid and the economics of the agents (DERs and loads, principally) which comprise its supply and demand.
1. Topology Processing (TP): The grid's wires, poles, and transformers may exist in multiple configurations and can be reconfigured to mitigate peaks, redistribute load, or reduce the number of customers impacted during an outage. Before determining which assets may inject power into the grid, the operator must know the state of the infrastructure in the grid. This information enables the operator to know that instructions sent to DERs will not violate system design criteria. Key to topology processing is not just information about switches, poles and wires, but also about the availability of DERs in real-time. The DSM will, as such, maximize its value with real time insight into the status of DERs on the network.
2. DSSE: State Estimation (SE) is a power systems estimation method used at the bulk level to forecast supply and demand imbalances in near real time and dispatch assets accordingly. The extension of that method to the distribution system is DSSE and provides similar dispatch-grade inputs to the utility.
3. Short Term Load Forecasts (STLF): During the day of, load forecasts will be made based on DSSE inputs through a variety of advanced statistical methods including Artificial Neural Networks and Convolutional Neural Networks. These load forecasts will be made for intra-hour, inter-hour, and inter-day time periods. The forecasts will generate an estimate of the amount of load needed to be served in any given interval, as well as the amount of generation expected in any given interval for intermittent resources such as wind and solar.
4. Optimal Power Flow (OPF): Based on the load forecast estimations, DSSE computations, and 3 phase AC unbalanced distribution system modelling, DERs will receive operation instructions for the next day, the next hour, and the next sub hour intervals. The optimal power flow equation incorporates the bids by demand side DERs and offers by supply side DERs to generate a solution which minimizes overall grid cost. The optimal power flow engine will, in addition to modelled grid conditions, take into account contingencies, redundancies, and other security constraints to generate an optimal dispatch. The rules surrounding these constraints will be contained in the DSM rules and regulations.

### Communication

1. DERs in the DSM can be controlled by their owners, by DER operators, by aggregators, by the utility whose service territory they reside within, or by the DSM which they have elected to participate in.
2. The point of control at the DER or aggregator or aggregator of aggregator level will communicate a signal between the DSM and the DER based on the instructions generated through the pricing and dispatch engine's outputs.
3. Market Participant Interface (MPI)
   a. The Market will have an MPI through which Market Participants (MPs) offer, bid, or negotiate pricing and unit commitment.
   b. The market will have a Market Participate Dispatcher (MPD).
   c. The MPI will be designed to be utilized by any third-party developer who wants to operate a qualified DER in the DSM.
   d. The MPI will, at a minimum, display:
      i. DER information to/from the DSM
      ii. Real-time run information
      iii. Scheduled, unscheduled, accepted and / or declined energy services transactions
         Pricing, participant and asset specific, broken out by location and time period

### ISO/RTO/Vertically Integrated Utility Integration

ISOs, RTOs, and vertically integrated utilities manage supply and demand at the bulk level. Currently, the entities buying load from ISOs and RTOs are, in large part, distribution utilities. As DER penetration increases and DERs'share of generation and load increase, the DSM may be the entity that not only purchases power from the ISO/RTO but also an entity that sells power to it or one that manages the generation bids from the ISO/RTO against the generation and supply bids at the distribution level.
As the distribution utility business model is further impacted by DERs, the DSM may be integrated with ISOs/RTOs to impact pricing in the ISO/RTO directly or indirectly.
   Directly-Separated: DERs submit bids and offers to the ISO/RTO through the DSM. The DSM then adds its own distribution specific values to the distribution level assets to ensure their payments reflect the value they bring to the grid.
   Direct-Integrated: All bulk and distribution level assets bid in their costs and energy demand prices. The integrated market generates prices for dispatch at the distribution and bulk level and operates units within one market construct.
   Indirectly: The DSM purchases load from the ISO/RTO at levels reflective of cleared load in the DSM. DERs receive a DSM specific adder, bulk generators have their sales impacted by DERs generating within the distribution grid.

### Market Rules

A set of market rules which codify the rights and responsibilities of all participants will govern activity in the DSM. Such rules may be defined by utilities, regulatory bodies, wholesale markets, or independently with its market participants.

### Metering and Settlement

The DSM is based in large part on new transactions between distributed resources which previously only consumed power from a central entity.
These new transactions require new metering and settlement.
Metering, Measurement & Verification:
   Proper operation of the market requires metering that captures the instantaneous changes in grid impacts effected by MPs
   Metering will allow for:
      More accurate Load forecasting
      More accurate price and dispatch signals
      The DSM will encourage innovation in metering and verification to better be able to account for, and compensate MPs for, the various grid services provided.
Settlement
   Transactions in the DSM will settle in set intervals between the MP and the DSM
   Peer-to-peer transactions may be entered into within the DSM, with network driven pricing being an input, and settlement of those transactions handled via the DSM for at least the network driven pricing portion.
   Settlement will be done based on records contained in a centralized, i.e. DSM controlled, or distributed, i.e. DER controlled, ledger, or a combination of the two.
   Prices paid for energy generation may be different from those charged for energy consumption.

### Secondary Markets

DERs participating in the DSM will receive fixed payments over defined time periods. Those fixed payments may, depending on the asset's characteristics, pose an investment recovery risk.

To mitigate each DER's operational and market price risk, secondary markets for the energy services provided by the DERs, or for the DERs themselves, will be incorporated into either the DSM explicitly, or be available to DER owners or DER aggregators on secondary markets.

These hedging mechanisms will allow DER owners to lock in revenue streams against the costs of their assets for a stated price.

The hedging mechanisms may include location and time specific contracts for differences in which participants pay a fixed price or receive a fixed price in, for example, return for the market revenues they do not wish to take risk on. External/Environmental Markets

DER carbon abatement, particulate abatement, and other environmental factors may be included in bids and offers submitted by participants.

DERs may submit offers containing their emissions characteristics.

Consumption bids in the DSM may include adders for emissions abatement. For example, a price of X for generation with a certain level of CO2 emission and a price of Y for generation with a higher level of CO2 emission. In this way, participants may more quickly express their preferences for emissions abatement.

### Long Term Markets

Long term markets are ones that contemplate asset decisions on time frames reflective of installation, investment, and siting, as opposed to operation and maintenance. The Distributed System Market will provide a DER investment price signal based on a combination of its short-term price signals and functionality which evaluates long-term trends in the distribution market such as hosting capacity, rate design, and system needs. It may evaluate these long-term trends in either an open market visible to all investors, or a shadow market defined by transactions hidden from the general market.

The value of DERs may be based on expected revenues realized through long-term provision of specific services within a DSM, evaluated at net present value, e.g. capital deferral services. The net present value will be evaluated based on a mix of user-defined and DSM-supplied growth rates, interest rates, asset costs, and expected revenues, among other variables. Those various variables will be evaluated by the DSM and participating members in a risk-adjusted, probabilistic fashion that accounts for expectations of, among other variables, weather, long-term load growth, and asset life.

Long-term markets may generate their own prices for DER investment. These long-term market prices may fully or partially replace the short-term prices generated in a DSM. In instances in which long-term prices fully replace short term ones, the DSM may still evaluate unit dispatch and communicate signals to DERs based on a shadow market in which an optimization engine generates instructions with non-binding prices, similar to the above described ones, as the basis for dispatch.

Regardless of full or partial use of long-term value for asset compensation, the DSM may generate an investment portal for DERs in which the long-term value is presented to prospective investors. The DSM may take responsibility for ensuring the payment is made for certain periods of time, contract with third parties to ensure the payment is made or rely on investors to make the asset investment risk on their own and contract for their own investment protection.

The DSM's central role will be one of updating long term signals such as utility costs of service to ISO/RTO capacity costs to project developer siting values at more granular location- and time-specific intervals via the transformation of short term markets outcomes into long term markets signals.

By updating these signals at more granular location and time-specific intervals, the DSM will enable coordination of planning efforts between state and federal regulatory bodies, ISOs/RTOs, and utilities. Doing so will reduce waste in the system and align incentives across actors, within and between regions.

### DER Interconnection

The DSM will be able to provide interconnection assessments to the distribution infrastructure owner/operator as well as to the DER developer. These assessments will inform the revenue a DER may expect to realize over the course of its lifetime, the costs to install the DER, and the costs to operate the DER, and to the infrastructure owner/operator impact on reliability, safety, security and hosting capacity, among other variables, of a particular DER's installation and use.

The revenues the DER may realize can be tied to the benefits the DER brings to the system based on the DSM.

The integration with the utility's interconnection system will facilitate and potentially drive increased DER installation in the utility's footprint and aide DER developers in selecting sites based on likely profitability.

Alternatively or in addition to the embodiments described above, Distributed System Markets could also be de-coupled from the utility and ISO/RTO systems and function as independent, autonomous microgrids in which smaller non-utility entities manage asset health and smaller non-ISO/RTO entities provide reliability.

The system as disclosed above can integrate physical system conditions and multiple DER ownership models, and provides a bridge between DSM and wholesale/utility supply and demand to operate a market which sites and utilizes assets optimally. Whereas Net Energy Metering, Demand Response, and other DER compensation mechanisms target specific technologies and grant them mostly undifferentiated rates, the DSM is technology agnostic, subject to business rules, and is instead focused on generating reductions in just and reasonable grid costs by assigning value based on granular location- and time-specific valuations.

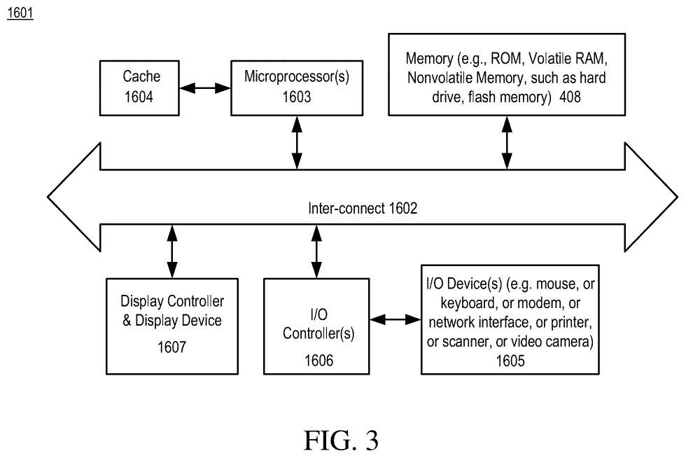

FIG. 3 shows a block diagram of a data processing system components of which can be used as the processor in various embodiments of the disclosed systems and methods. While FIG. 3 illustrates various components of a computer system, it is not intended to represent any particular architecture or manner of interconnecting the components. Other systems that have fewer or more components may also be used.

In FIG. 3, the system 1601 includes an inter-connect 1602 (e.g., bus and system core logic), which interconnects a microprocessor(s) 1603 and memory 1608. The microprocessor 1603 is coupled to cache memory 1604 in the example of FIG. 3.

The inter-connect 1602 interconnects the microprocessor(s) 1603 and the memory 1608 together and also interconnects them to a display controller and display device 1607 and to peripheral devices such as input/output (I/O) devices 1605 through an input/output controller(s) 1606. Typical I/O devices include mice, keyboards, modems, network interfaces, printers, scanners, video cameras and other devices that are well known in the art.

The inter-connect 1602 may include one or more buses connected to one another through various bridges, controllers and/or adapters. In one embodiment the I/O controller 1606 includes a USB (Universal Serial Bus) adapter for controlling USB peripherals, and/or an IEEE-1394 bus adapter for controlling IEEE-1394 peripherals.

The memory 1608 may include ROM (Read-Only Memory) and volatile RAM (Random Access Memory), and non-volatile memory, such as hard drive, flash memory, etc. Volatile RAM is typically implemented as dynamic RAM (DRAM) that requires power continually in order to refresh or maintain the data in the memory. Non-volatile memory is typically a magnetic hard drive, a magnetic optical drive, or an optical drive (e.g., a DVD RAM), or other type of memory system which maintains data even after power is removed from the system. The non-volatile memory may also be a random access memory. The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In an embodiment, one or more servers supporting the platform are implemented using one or more data processing systems as illustrated in FIG. 3. In an embodiment, user devices such as those used to access the user interfaces described above are implemented using one or more data processing system as illustrated in FIG. 3.

In some embodiments, one or more servers of the system illustrated in FIG. 3 are replaced with the service of a peer-to-peer network or a cloud configuration of a plurality of data processing systems, or a network of distributed computing systems. The peer-to-peer network, or cloud-based server system, can be collectively viewed as a server data processing system.

Embodiments of the system disclosed above can be implemented via the microprocessor(s) 1603 and/or the memory 1608. For example, the functionalities described above can be partially implemented via hardware logic in the microprocessor(s) 1603 and partially using the instructions stored in the memory 1608. Some embodiments are implemented using the microprocessor(s) 1603 without additional instructions stored in the memory 1608. Some embodiments are implemented using the instructions stored in the memory 1608 for execution by one or more general-purpose microprocessor(s) 1603. Thus, the disclosure is not limited to a specific configuration of hardware and/or software.

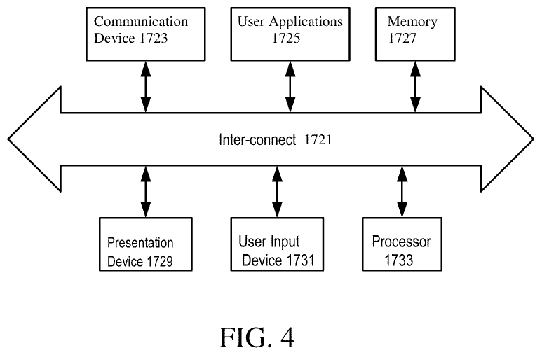

FIG. 4 shows a block diagram of a user device. In FIG. 4, the user device includes an inter-connect 1721 connecting a communication device 1723, such as a network interface device, a presentation device 1729, such as a display screen, a user input device 1731, such as a keyboard or touch screen, user applications 1725 implemented as hardware, software, firmware or a combination of any of such media, such various user applications (e.g. apps), a memory 1727, such as RAM or magnetic storage, and a processor 1733 that, inter alia, executes the user applications 1725.

In one embodiment, the user applications implement one or more user interfaces displayed on the presentation device 1729 that provides users and the system the capabilities to, for example, access a Wide Area Network (WAN) such as the Internet, and display and interact with user interfaces provided by the platform, such as, for example the user interfaces described above in this disclosure. In an embodiment, users use the user input device 1731 to interact with the device via the user applications 1725 supported by the device.

While some embodiments can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed above can be embodied, at least in part, in software. That is, the techniques may be carried out in a special purpose or general purpose computer system or other data processing system in response to its processor, such as a microprocessor, executing sequences of instructions contained in a memory, such as ROM, volatile RAM, non-volatile memory, cache or a remote storage device. Functions expressed herein may be performed by a processor in combination with memory storing code and should not be interpreted as means-plus-function limitations.

Routines executed to implement the embodiments may be implemented as part of an operating system, firmware, ROM, middleware, service delivery platform, SDK (Software Development Kit) component, web services, or other specific application, component, program, object, module or sequence of instructions referred to as “computer programs.” Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A machine-readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer-to-peer networks. Different portions of the data and instructions can be obtained from different centralized servers and/or peer-to-peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine-readable medium in entirety at a particular instance of time.

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others.

In general, a machine-readable medium includes any mechanism that provides (e.g., stores) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques disclosed above. Thus, the techniques are neither limited to any specific combination of hardware circuitry and software nor to any particular source for the instructions executed by the data processing system.

The above embodiments and preferences are illustrative of the present invention. It is neither necessary, nor intended for this patent to outline or define every possible combination or embodiment. The inventor has disclosed sufficient information to permit one skilled in the art to practice at least one embodiment of the invention. The above description and drawings are merely illustrative of the present invention and that changes in components, structure and procedure are possible without departing from the scope of the present invention. For example, elements and/or steps described herein in a particular order may be practiced in a different order without departing from the invention. Thus, while the invention has been particularly shown and described with reference to embodiments thereof, it will be understood by those skilled in the art that various changes in form and details may be made therein without departing from the spirit and scope of the invention.

What is claimed is:

1. A computer-implemented DSM system which utilizes the integration of physical system conditions, one or multiple DER ownership or operating models, and a bridge with bulk power system or wholesale market supply and demand to site, utilize and remunerate assets optimally, comprising:
a) a data store including a plurality of bulk power system pricing data values originating from at least one bulk system operatively connected to an electric power distribution network, a plurality of distribution system topology data values originating from at least one distribution system operatively connected to the electric power distribution network, and a plurality of DER demand and characteristic data values originating from a plurality of DER operators operatively connected to the electric power distribution network; and
b) one or more computer processors coupled to the data store and in communication with the plurality of distributed electric resources on said electric power distribution network, the one or more computer processors being programmed, upon receiving one or more requests, to:
i) read from the data store at least one of said plurality of bulk power system pricing data values, at least one of said plurality of distribution system topology data values, and at least one of said plurality of DER operational and characteristic data values;
ii) use each of said values read from the data store to perform a technical and economic optimization to assign an energy service value, said energy service value representing a value of supply, delivery, and storage of energy, as well as other grid services, by a specific DER to a specific location over a specific time frame; and,
iii) use said energy service value to provide a market participant interface through which market participants offer, bid, or negotiate value and service commitment.

2. The computer-implemented DSM system according to claim 1, wherein said one or more computer processors is further programmed to use a distribution system state estimator, an optimal power flow engine, an economic optimization engine, and three-phase AC unbalanced distribution system modelling to generate energy service values, along with associated dispatch instructions.

3. The computer-implemented DSM system according to claim 2, wherein said one or more computer processors is further programmed to transmit said dispatch instructions to at least one operator of said at least one DER.

4. The computer-implemented DSM system according to claim 1, wherein said energy delivery value comprises a value to the bulk system of delivery of energy by the specific DER to the specific location over the specific time frame.

5. The computer-implemented DSM system according to claim 1, wherein said energy service value comprises a value to the distribution system of delivery of energy services by the specific DER to the specific location over the specific time frame.

6. The computer-implemented DSM system according to claim 1, wherein said market participant interface displays DER information to/from the DSM.

7. The computer-implemented DSM system according to claim 1, wherein said market participant interface displays real-time run information.

8. The computer-implemented DSM system according to claim 1, wherein said market participant interface displays scheduled, unscheduled, accepted and/or declined energy services transactions.

9. The computer-implemented DSM system according to claim 1, wherein said market participant interface displays participant and asset-specific pricing, broken out by location and time period.

10. The computer-implemented DSM system according to claim 1, wherein said bulk power system pricing data comprises historical, same day, or day-ahead pricing.

11. The computer-implemented DSM system according to claim 1, wherein said bulk power system pricing data comprises long term planning data.

12. The computer-implemented DSM system according to claim 1, wherein said distribution system topology data comprises a system model of the distribution system and constraints associated with the distribution system.

13. The computer-implemented DSM system according to claim 1, wherein said DER operational and characteristic data comprises a number of DERs in each of a plurality of categories of DER.

14. The computer-implemented DSM system according to claim 1, wherein said DER operational and characteristic data comprises a number of DERs applying for connection to the grid.

15. The computer-implemented DSM system according to claim 1, wherein said DER operational and characteristic data comprises capacities and time frames in which a number of DERs can connect to the grid.

16. The computer-implemented DSM system according to claim 1, wherein said one or more computer processors is further programmed to provide secondary markets for the energy services provided by the DERs or for the DERs themselves.

17. The computer-implemented DSM system according to claim 1, wherein said market participant interface displays environmental factors in bids and offers submitted by participants.

18. The computer-implemented DSM system according to claim 1, wherein said market participant interface is configured to provide competitive procurement of DER to meet long term bulk system or distribution system needs.

19. The computer-implemented DSM system according to claim 1, wherein said market participant interface is configured to provide formation of long term DER programs.

20. The computer-implemented DSM system according to claim 1, wherein said other grid services comprise at least one of: voltage, frequency, capacity, ramping, blackstart, microgriding, hosting capacity.

21. The computer-implemented DSM system according to claim 1, wherein said one or more computer processors is further programmed to use analytics in the distribution system to generate energy service values, said analytics comprising one or more of:
power flow, power flow optimization, constraint management, and hosting capacity analyses.
